(19) United States
(12) Patent Application Publication
(10) Pub. No.: US 2018/0194928 A1
(43) Pub. Date: Jul. 12, 2018

(54) OPTICALLY FUNCTIONAL MATERIAL HAVING HUE AND LUSTER, PREPARATION OF SAME, AND APPLICATION OF SAME

(71) Applicant: SUZHOU NANOFOREVER MATERIALS TECHNOLOGY CO., LTD., Suzhou (CN)

(72) Inventors: Changqing YE, Suzhou (CN); Qiang WEN, Suzhou (CN); Deyun LIU, Suzhou (CN); Yanlin SONG, Suzhou (CN)

(21) Appl. No.: 15/675,094

(22) Filed: Aug. 11, 2017

Related U.S. Application Data
(63) Continuation-in-part of application No. PCT/CN2016/073732, filed on Feb. 6, 2016.

(30) Foreign Application Priority Data
Feb. 13, 2015 (CN) 201510078604.2
Feb. 13, 2015 (CN) 201510079857.1

(51) Int. Cl. C08K 5/1545; C08K 5/00; C08K 5/42; C09D 11/037; G03G 9/09; C09D 7/41

(52) U.S. Cl. CPC C08K 5/1545; C08K 5/0041; C08K 5/42; C08K 2201/003; G03G 9/0906; C09D 7/41; C09D 11/037

(57) ABSTRACT

Provided is an optically functional material. The optically functional material includes a nano-microsphere layer formed by periodically arranged nano-microspheres, which is a closely packed structure, providing the optically functional material with luster. Wherein, the nano-microsphere layer includes colorless, white, gray, black or chromatic nano-microspheres. The optically functional material of the present invention has a suitable Poisson ratio and Mohs hardness within a specific range of values, and can achieve relative independence between the luster and hue, thus obtaining the special effect of randomly mixed and combined luster and hue as required. Further provided is a method of preparing an optically functional material.

### CROSS-REFERENCE TO RELATED APPLICATION

This application is a continuation in part of International patent application No. PCT/CN2016/073732 (filed on Feb. 6, 2016) which claims the benefit and priority of Chinese patent application No. CN201510079857.1 (filed on Feb. 13, 2015) and CN201510078604.2 (filed on Feb. 13, 2015), each of which is incorporated herein by reference in its entirety and for all purposes.

### FIELD OF THE INVENTION

The present invention relates to an optically functional material and, more particularly to an optically functional material having relatively independent hue and luster.

### BACKGROUND OF THE INVENTION

The variety of colors can be divided into two categories comprising achromatic colors and chromatic colors.

The achromatic colors refer to white, black and a variety of different shades of gray formed by combination of white and black. The achromatic colors, according to a certain rule of variation, can be arranged in a series, gradually changing from white to light gray, to medium gray, to dark gray, and to black, which are called black & white series in colorimetry. Pure white is ideal for completely reflecting, and pure black is ideal for completely absorbing. The achromatic colors have only one basic characteristic—brightness. They do not have the characteristics of hue and purity, that is, their hue and purity are theoretically equal to zero. The brightness of colors can be expressed in black and white, the closer to the white, the higher the brightness; the closer to the black, the lower the brightness. White and black used as pigments, can adjust the color reflectivity of an object, so as to increase the brightness or reduce the brightness of the object.

The chromatic colors refer to red, orange, yellow, green, cyan, blue, purple and other colors. Red, orange, yellow, green, cyan, blue and purple of different brightnesses and purities all belong to chromatic colors. The chromatic color is determined by wavelength and amplitude of light, the wavelength determines the hue, and the amplitude determines the tone. The chromatic colors have three basic characteristics: hue, purity (also known as saturation, degree of saturation), and brightness, which in colorimetry are also known as the three elements or three attributes of colors. Hue is the biggest feature of a chromatic color. The so-called hue refers to the name that can describe more precisely a certain color, such as rose red, orange yellow, lemon yellow, cobalt blue, ultramarine, jade green, etc. From the view of optical physics, the varieties of hues are decided by the spectral components of light shining into the human eye. For monochromatic light, the appearance of the hue depends entirely on the wavelength of the light; and for mixed color light, it depends on the relative amount of lights of various wavelengths. The color of an object is determined by the spectral component of the light source and the reflection (or transmission) characteristic of the surface of the object.

The expressing form of color is tint, including pigmentary color and structural color. The colors of most of the non-luminous objects in everyday life are presented in pigmentary colors. The visible light is irradiated onto the object, and the light waves of different wavelengths are selectively absorbed, reflected (transmitted) by the pigments, providing a specific reflection (transmission) spectrum which, through the observation of the human eye, finally forms the sensation of color in the human brain. The pigmentary colors are consistent with the subtractive color mixture principle. Theoretically, only three subtractive original colors (normally C (Cyan), M (Magenta), Y (Yellow)) can be mixed to produce all the colors in the hue circle.

Structural color, also known as physical color, is a luster effect produced from the interference diffraction effect caused between the material microstructure and the corresponding wavelength of light. The structural color is independent of the tinctorial pigment of the constituent material of the structure and is an optical effect caused by the sub-microstructure of the organism. The crests, textures, facets and particles of the surface or surface layer of an organism body can produce reflection or scattering effect of light, thus resulting in a special color effect. For example, the colors of the feathers of birds and butterfly wings are mainly caused by the interference of light; the skin around turkey neck appears to be blue, and the skin on a primate's face, buttocks and reproductive area is blue, because the blue-violet fraction in the incident light is reflected by a large number of fine particles (whose diameter is equal to the wavelength of the blue-violet light) in the epidermal tissue, and the red-yellow fraction of the incident light is absorbed by the melanin in the dermal tissue through the particle layer.

As structural colors have the advantages of non-fading, environmental protection and iridescence effect, etc., they have broad application prospects in the display, decoration, anti-fake and other fields. It is possible to promote the development of the bionic structural color processing and micro-nano optical technology by studying the formation mechanism of structural colors of organism in nature and its application.

Photonic crystal, an artificial microstructure formed by media of different dielectric constants in periodic arrangement, was independently proposed in 1987 by S. John and E. Yablonovitch, respectively. From the point of view of material structure, the photonic crystal is a class of crystal that are artificially designed and manufactured with a periodic dielectric structure in the optical scale. The special periodic structure of the photonic crystal provides it with inhibition effect to photons of a particular wavelength or waveband and makes it possible to form a photonic band-gap similar to the electronic energy band in semiconductor, and the photonic band-gap in photonic crystal is called Photonic Band-Gap, referred to as PBG. As with the semiconductor material, the periodic arrangement of the dielectric constant produces a certain “potential field”. When the dielectric constants of two media are sufficiently large, the Bragg scattering occurs at the interface of the media, resulting in photonic band-gap, and the light whose energy falls to the band gap will not be transmitted and will be reflected in the form of mirror, thus forming a structural color, the reflection has a high reflectivity and a single spectrum and may give a bright and pure luster effect with a band-gap wavelength color. This is also the source of the luster of the photonic crystal material.

In the prior art, in order to effectively utilize the advantages of non-fading, environmental protection and iridescence effect, etc. of structural colors, most of the researches on optically functional materials containing photonic crystal structures are focused on the visual effects of highlighting the structural color of photonic crystals. For example, some dark light-absorbing media are used to weaken the stray light of non-structural color of the photonic crystal to improve its color saturation, so that the formed optically functional materials can provide more pure, highly saturated structural color luster. As the waveband of the structural color is single, it is not possible to achieve color mixing, or to show non-spectral colors, making the formed optically functional materials present a single color, which affects the aesthetic perception and limits the practical applications.

As mentioned above, the structural color is independent of the pigmentary color constituting the structural material per se, and the structural color spectrum is a specular reflection spectrum with a single band, and has a very low relative amount in the whole reflection spectrum, which has little effect on the hue of the whole material and is presented as one pure color luster effect.

Conventional methods for preparing photonic crystals comprise both “top-down” physical processing methods, and “bottom-up” chemical assembly methods, in which single-dispersed nano-microspheres are assembled as a closely packed periodic structure, and a refractive index difference exists between the nano-microspheres arranged in the periodic structure and the filling medium between the spheres, such periodic structure with refractive index difference forms the photonic band-gap (PBG). The self-assembly method has advantages of low cost, simple method and no need for a complicated equipment, and can realize the preparation of photonic crystals with different functions by controlling the morphology and structure of the nano-microspheres in the synthesis process. At present, the literatures and patents on structural color mostly improve, from the point of view of structural colors, the structure and material thereof, with the luster and hue directly corresponding to the band-gap wavelength λ and the structural color in the spectrum is chromatic light of a single band, and its color is pure, shiny and bright, but meanwhile it cannot achieve mixing of blended hue because of its single band.

Therefore, it is desirable to provide an optically functional material capable of presenting a plurality of colors by mixing and blending, and independently exhibiting a saturated and pure spectral color luster.

### SUMMARY OF THE INVENTION

In view of the advantages and disadvantages of structural color, it is an object of the present invention to provide an optically functional material, and the present invention proposes a concept in which the luster and color are independent of each other and the luster and hue are independent of each other. This optically functional material not only utilizes the structural color of the photonic crystal, but also combines with the properties of the material constituting the photonic crystal. The inventors of the present invention have found that the above-mentioned optically functional material has luster and color which are independent of each other when the Poisson ratio and Mohs hardness are within a suitable range, respectively. The luster and color of the optically functional material are independent of each other, meaning that the luster is primarily influenced by the microscopic nanoscale structure of the material, and its color is primarily determined by the absorption of light by the material constituting the optically functional material, although the luster and color may affect each other in the visual effects of human eye, the generation causes of luster and color are different, so the two are independent of each other. The luster and hue of the optically functional material are independent of each other, meaning that the luster is primarily affected by the microscopic nanoscale structure of the material, and the hue of its color depends primarily on the absorption of light by the material constituting the optically functional material, although the luster and hue may affect each other in the visual effects of human eye, the generation causes of luster and hue are different, so the two are independent of each other.

The present invention combines the structural color of the photonic crystal with the color or hue of the material constituting the photonic crystal, and adjusts the combination of colors or hues of the two to obtain a more rich color or hue independent of the structural color, and combines it with the color spectrum, so as to achieve relative independence of luster and color or hue, and to obtain a special effect of randomly crossed and combined luster as required.

In the present application, when the color of the optically functional material is white, gray or black, the luster and the color are independent from each other; when the color of the optically functional material is a color having a hue, the luster and the hue are independent from each other.

The term “chromatic color” in the present application refers to a color having any hue in the hue circle.

The term “PDI” in the present application refers to the polydispersity index of the particle diameter of the emulsion microspheres.

In order to achieve the above object, the present invention provides an optically functional material comprising a nano-microsphere layer formed by periodically arranged nano-microspheres, the nano-microsphere layer being a closely packed structure, so as to provide the optically functional material with luster; wherein the nano-microsphere layer comprises colorless nano-microspheres, white nano-microspheres, gray nano-microspheres, black nano-microspheres or chromatic nano-microspheres.

Further, the nano-microsphere layer comprises a plurality of nano-microspheres of different colors, and the color of each nano-microsphere is selected from white, gray, black or chromatic colors.

Further, the optically functional material is transparent, semitransparent or slightly transparent.

Further, the nano-microsphere layer comprises white nano-microspheres and at least one kind of chromatic nano-microspheres.

Further, the nano-microsphere layer comprises chromatic nano-microspheres having different hues.

Further, the nano-microsphere layer comprises white nano-microspheres, black nano-microspheres and chromatic nano-microspheres.

Further, the nano-microsphere layer comprises black nano-microspheres and chromatic nano-microspheres.

Further, the nano-microsphere layer comprises gray nano-microspheres and chromatic nano-microspheres.

Further, the nano-microsphere layer comprises white nano-microspheres and black nano-microspheres.

Further, the nano-microsphere layer comprises gray nano-microspheres and black nano-microspheres.

Further, the nano-microsphere is selected from the group consisting of cyan nano-microsphere, magenta nano-microsphere, yellow nano-microsphere and combinations thereof.

Further, the color of the nano-microspheres is the color of the nano-microspheres per se or is formed by tinting.

Further, the tinting is performed prior to self-assembly.

Further, the tinting is performed during a self-assembly process.

Further, the tinting is performed after self-assembly.

Further, the raw material of the nano-microspheres is selected from the group consisting of polystyrene, polyacrylate, polyacrylic acid, silica, alumina, titania, zirconium oxide, ferroferric oxide, polyimide, silicon resin, and phenolic resin.

Further, the monodispersity PDI of the nano-microspheres is less than 0.5.

Further, the PDI of the nano-microspheres is less than 0.05.

Further, the nano-microsphere has a particle diameter of 80˜1100 nm.

Further, the nano-microsphere has a particle diameter of 120˜400 nm.

Further, the nano-microsphere layer forms photonic crystals.

Further, the thickness of the nano-microsphere layer is 1˜50 μm.

Further, the voids between the nano-microspheres are filled with a filling medium.

Further, the filling medium is colorless, white, gray, black or chromatic.

Further, the color of the filling medium per se is chromatic.

Further, the filling medium may be transparent, semitransparent or slightly transparent.

Further, the optically functional material is transparent, semitransparent or slightly transparent.

Further, the filling medium is a gas, a liquid or a solid.

Further, the filling medium contains a colored substance.

Further, the colored substance is a dye, a pigment, or a resin masterbatch.

Further, the colored substance is selected from the group consisting of methyl blue, lemon yellow, rhodamine 6G, red acrylic resin masterbatch, orange epoxy masterbatch, blue epoxy masterbatch, green polyurethane resin masterbatch, and combinations thereof.

Further, the liquid filling medium is selected from the group consisting of silicone oil, mineral oil, vegetable oil and animal oil and fat.

Further, the solid filling medium is selected from the group consisting of silica, titania, zinc oxide, carbon black, silicon resin, polyurethane resin, epoxy resin, acrylic resin, alkyd resin and polyester.

Further, the nano-microsphere layer comprises chromatic nano-microspheres, and the color of the filling medium per se is chromatic.

Further, the nano-microsphere layer comprises colorless nano-microspheres, white nano-microspheres, gray nano-microspheres or black nano-microspheres, the color of the filling medium per se is chromatic.

Further, the luster of the optically functional material is infrared light, visible light or ultraviolet light having a wavelength of 200˜2000 nm. Preferably, the luster of the optically functional material is visible light having a wavelength of 480˜550 nm, 580˜600 nm, 550˜600 nm, or 600˜640 nm.

Further, the optically functional material has Poisson ratio ranging from 0.1 to 0.7, such as 0.1, 0.2, 0.3, 0.4, 0.5, 0.6 or 0.7; preferably from 0.1 to 0.6.

Further, the optically functional material has Mohs hardness ranging from 1.9 to 4.1, such as 1.9, 2.2, 2.4, 2.6, 2.8, 3.0, 3.2, 3.4, 3.5, 3.7 or 4.1.

In the above technical scheme, the combination of the hue of the nano-microsphere per se and the hue of the filling medium can realize the hue adjustment of the optically functional material. The luster of the optically functional material is set by setting the characteristics of the periodic arrangement of the nano-microspheres and the filling medium and the refractive index, and the relationship therebetween follows the following formula:

λ=1.6333×d×\sqrt{0.74×n_{A}²+0.26×n_{B}²}

wherein λ is the band-gap wavelength, d is the periodic constant, i.e. the particle diameter of the microspheres, n_{A} is the refractive index of the nano-microspheres, and ns is the refractive index of the filling medium. 0.74 and 0.26 are the volume fraction of the nano-microspheres and the gap medium in the whole material, respectively.

The nano-microspheres may be selected from one or more than two (including two) materials with similar refractive indexes, and the refractive index deviation of the materials of the nano-microspheres is less than 2%. In a preferred technical scheme, the refractive index deviation of the nano-microspheres is less than 0.5%.

In the above-mentioned technical scheme, the material of the nano-microspheres is one or a mixture of one or more selected from the group consisting of polystyrene, polyacrylate, polyacrylic acid, silica, alumina, titania, zirconium oxide, ferroferric oxide, polyimide, silicon resin and phenolic resin.

In the above-mentioned technical scheme, the filling medium is one or a mixture of two of a liquid filling medium, a solid filling medium, a liquid filling medium provided with a colored substance inside, and a solid filling medium provided with a colored substance inside. The liquid filling medium is one or a mixed liquid of one or more selected from silicone oil, mineral oil, vegetable oil or animal oil and fat. The solid filling medium is selected from silica, titania, zinc oxide, carbon black, silicon resin, polyurethane resin, epoxy resin, acrylic resin, alkyd resin, and polyester.

Further, the optically functional material has Poisson ratio ranging from 0.1 to 0.7 (such as 0.1, 0.2, 0.3, 0.4, 0.5, 0.6 or 0.7), and Mohs hardness ranging from 1.9 to 4.1 (such as 1.9, 2.2, 2.4, 2.6, 2.8, 3.0, 3.2, 3.4, 3.5, 3.7 or 4.1).

In another aspect, the present invention provides a preparation method for an optically functional material, comprising the following steps:

(1) dispersing the nano-microspheres in a continuous phase to form a colloidal dispersion of the nano-microspheres;

(2) under the action of external force, self-assembling the colloidal dispersion of the nano-microspheres to form periodically closely arranged structure at the phase interface;

(3) removing part or all of the continuous phase as required;

Further, the nano-microspheres in the step (1) are tinted nano-microspheres. Preferably, after formation of the colloidal dispersion of the nano-microspheres, a colorant is added to the colloidal dispersion of the nano-microspheres to tint the nano-microspheres.

Further, after removing the continuous phase, the voids between the nano-microspheres of the nano-microsphere layer are filled with a filling medium.

Preferably, the phase interface described in the step (2) comprises a gas-solid interface, a gas-liquid interface, a solid-solid interface or a liquid-liquid interface.

Preferably, the external force described in the step (2) comprises capillary force, electrostatic force, magnetic force, gravity, van der Waals force or hydrogen bond.

In the above technical scheme, the filling medium can be added into the nano-microsphere emulsion in the process of removing the continuous phase to be assembled together with the nano-microspheres, and can also be filled into the voids between the nano-microspheres after the nano-microspheres are assembled into a periodically closely arranged structure.

In the above technical scheme, the periodically closely arranged structure of the nano-microspheres is constructed by the self-assembly of the nano-microsphere emulsion, that is, the nano-microspheres are dispersed into another continuous phase, and the non-solvent filling medium is selected and dispersed, aided with a certain additive to form a nano-microsphere emulsion. The continuous phase is removed by corresponding technical means, and in the process the nano-microspheres and related additives are co-assembled to form a periodically closely arranged structure.

In the above technical scheme, the continuous phase substance of the nano-microsphere emulsion may be one or a combination of one or more selected from, but not limited to, water, methanol, ethanol, ethylene glycol and cyclohexane. In the nano-microsphere emulsion, the content of the nano-microspheres is 0.5˜60% wt, the content of the non-solvent filling medium is 0˜35% wt, and the content of the additive is 0˜20% wt.

In the above technical scheme, the nano-microsphere emulsion additive is used for adjusting the rheological properties, volatility, film-forming properties and the like of the continuous phase, and the nano-microsphere emulsion additive may be selected from, but not limited to, cellulose, acrylic acid emulsion, surfactant, epoxy resin, polyurethane resin, and the like.

The optically functional material according to the present invention has a suitable Poisson ratio and Mohs hardness (within specific ranges, such as the Poisson ratio of 0.1-0.7, and Mohs hardness of 1.9-4.1), wherein the hue and luster of the material are independent of each other, and the luster is presented by a photonic crystal band-gap formed by nano-microspheres in periodic close arrangement and the filling medium with a refractive index difference therebetween, and by adjusting the size of the nano-microspheres and the refractive index difference between the nano-microspheres and the filling medium, and the presentation scope of the luster may cover the full visible spectrum, and can be extended to the ultraviolet, and infrared regions.

The optically functional material according to the present invention can be used in the preparation of ink pastes, pigment toners, and film coatings.

The optically functional material according to the present invention, in the form of ink colorants, pigment toners or film coatings, can be used in the preparation of paints, printing inks, packaging coatings, cosmetics, anti-fake materials, sensors and optical elements.

Due to the application of the above-described technical scheme, the present invention has the following advantages compared with the prior art:

The luster of the optically functional material having luster and hue according to the present invention can be arbitrarily adjusted in the infrared, visible or even ultraviolet range by regulation of the band-gap of the photonic crystal, and all hues of the hue circle can be achieved by providing a combination of the hues of the nanoparticles and the filling medium. The effect of luster and hue being relatively independent can be achieved, to realize a special color effect such as the red hue irradiating green light, the blue hue irradiating gold light and the like, and the luster can be changed along with the angle of view, producing a rainbow color change effect. Also at a specific angle an infrared ultraviolet radiation of a specific wavelength that is not visible to the naked eye can be reflected, thereby achieving special applications such as anti-fake, sensing and the like.

The objects, features and effects of the present invention can be fully understood by the following detailed description of concepts, the specific structures and the technical effects of the present invention in conjunction with the accompanying drawings.

### BRIEF DESCRIPTION OF THE DRAWINGS

FIG. 1 is an SEM photograph of the polystyrene emulsion microspheres in Example 1 after assembly;

FIG. 2 is the reflectance spectrum of the polystyrene emulsion microspheres assembly in Example 1, corresponding to its luster;

FIG. 3 is the absorption spectrum of the polystyrene emulsion microspheres in Example 1 after assembly, corresponding to its hue;

FIG. 4 shows the measuring light paths of the spectrophotometer in the examples: 1, sample to be measured; 2, light source, with an incident angle of 45°; 3, mirror reflected light path; 4, measuring light path 45 as 15, and at −15° to the mirror reflected light path; 5, measuring light path 45 as 15, at 15° to the mirror reflected light path; 6, measuring light path 45 as 25, at 25° to the mirror reflected light path; 7, measuring light path 45 as 45, at 45° to the mirror reflected light path; 8, measuring light path 45 as 75, at 75° to the mirror reflected light path; 9, measuring light path 45 as 110, at 110° to the mirror reflected light path;

FIG. 5, SEM photograph of the polystyrene emulsion microspheres in Example 25 after assembly;

FIG. 6, the reflectance spectrum of the polystyrene emulsion microspheres assembly in Example 25, corresponding to its luster;

FIG. 7, the absorption spectrum of the polystyrene emulsion microspheres in Example 25 after assembly, corresponding to its hue.

### DETAILED DESCRIPTION OF THE INVENTION

Example 1, preparation of a magenta optically functional material having a blue-green luster comprises the following steps:

\textcircled{1} preparing a monodisperse polystyrene microsphere emulsion with a diameter of 215 nm and a solid content of 5% by emulsion polymerization. The specific preparation method was:

a. weighing 0.58 g of sodium dodecyl sulfate, 0.2 g of rhodamine 6G and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microspheres had a diameter of 215 nm and PDI of 0.02;

\textcircled{2} compounding magenta monodisperse polystyrene microsphere emulsion with anhydrous ethanol by a volume ratio of 7:2, proceeding ultrasonic dispersion for 10 minutes, and a homogeneously mixed magenta nano-microsphere emulsion solution was obtained;

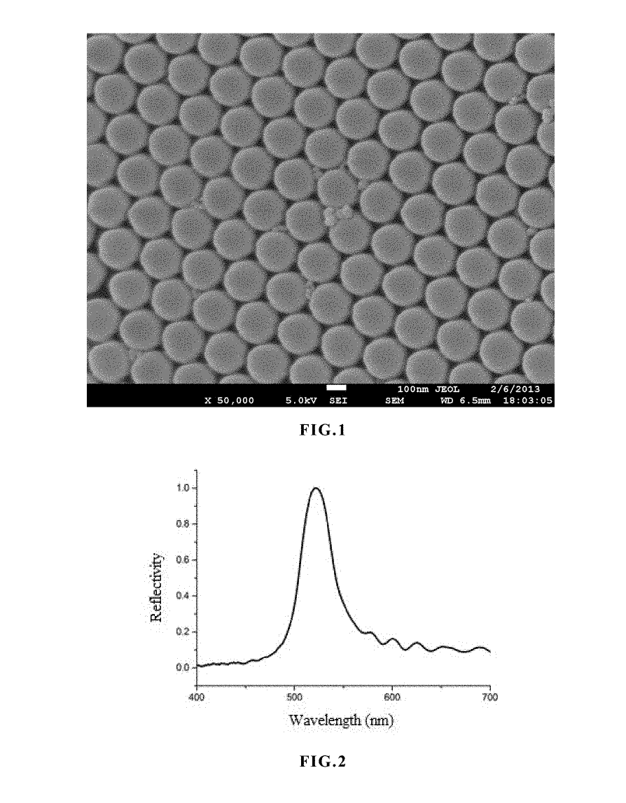

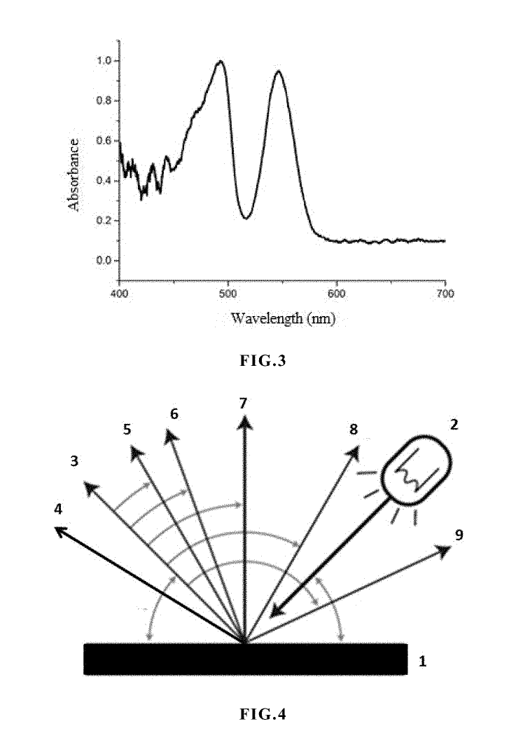

\textcircled{3} placing a cleaned glass sheet of 2.5 cm×2.5 cm on a heat carrier at 75° C.; after the temperature was stabilized, dropping 1 ml of the homogeneous magenta nano-microsphere emulsion solution obtained in the step \textcircled{2} on the glass sheet to spread evenly; after evaporation of the solvent, a bright and beautiful layer of photonic crystal coating presenting magenta hue and blue-green luster was formed on the surface of the glass, with a layer thickness of 5 microns. The color and luster parameters thereof were measured by X-rite MA-98 spectrophotometer, the SEM photograph of the polystyrene emulsion microspheres after assembly is shown in FIG. 1, the reflectance spectrum of the polystyrene emulsion microspheres is shown in FIG. 2, corresponding to its luster, and the absorption spectrum is shown in FIG. 3, corresponding to its hue, and the light source is D65/10°, with the measuring light path shown in FIG. 4, and the data are shown in Table 1.

TABLE 1

| Test Angle | L* | a* | b* |
|---|---|---|---|
| 45as-15 | 138.84 | 27.02 | −39.71 |
| 45as15 | 53.26 | 53.02 | −14.78 |
| 45as25 | 51.56 | 52.04 | −9.38 |
| 45as45 | 50.35 | 51.62 | −1.87 |
| 45as75 | 53.94 | 48.92 | 0.23 |
| 45as110 | 51.03 | 43.41 | −1.08 |

After testing, the optically functional material prepared in this example has Pission ratio of 0.35 and Mohs hardness of 2.2.

Example 2, preparation of a cyan optically functional material having a blue-green luster comprises the following steps:

\textcircled{1} preparing a monodisperse polystyrene microsphere emulsion with a diameter of 215 nm and a solid content of 5% by emulsion polymerization. The specific preparation method was:

a. weighing 0.58 g of sodium dodecyl sulfate and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microspheres had a diameter of 215 nm and PDI of 0.02;

\textcircled{2} weighing 0.18 g of acid blue 5 and dissolving in 20 ml of deionized water, proceeding ultrasonic dissolution for 20 minutes; compounding the blue dye solution with the monodisperse polystyrene microsphere emulsion and anhydrous ethanol by a volume ratio of 1:6:2, proceeding ultrasonic dispersion for 10 minutes, and a homogeneously mixed cyan nano-microsphere emulsion solution was obtained;

\textcircled{3} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting reddish cyan hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 2.

TABLE 2

| Test Angle | L* | a* | b* |
|---|---|---|---|
| 45as-15 | 51.38 | 3.44 | −45.60 |
| 45as15 | 127.46 | 4.57 | −53.06 |
| 45as25 | 83.07 | 1.93 | −53.79 |
| 45as45 | 51.35 | 1.64 | −59.23 |
| 45as75 | 52.89 | 5.91 | −51.94 |
| 45as110 | 56.51 | −8.56 | −53.53 |

After testing, the optically functional material prepared in this example has Pission ratio of 0.34 and Mohs hardness of 2.2.

Example 3, preparation of a yellow optically functional material having a blue-green luster comprises the following steps:

\textcircled{1} preparing a monodisperse polystyrene microsphere emulsion with a diameter of 215 nm and a solid content of 5% by emulsion polymerization. The specific preparation method was:

a. weighing 0.58 g of sodium dodecyl sulfate and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microsphere had a diameter of 215 nm and PDI of 0.02;

\textcircled{2} weighing 0.30 g of acid yellow 9 and dissolving in 20 ml of deionized water, proceeding ultrasonic dissolution for 20 minutes; compounding the yellow dye solution with the monodisperse polystyrene microsphere emulsion and anhydrous ethanol by a volume ratio of 1:6:2, proceeding ultrasonic dispersion for 10 minutes, and a homogeneously mixed yellow nano-microsphere emulsion solution was obtained;

\textcircled{3} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting yellow hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 3.

TABLE 3

| Test Angle | L* | a* | b* |
|---|---|---|---|
| 45as-15 | 114.92 | −14.80 | 58.19 |
| 45as15 | 87.48 | 1.25 | 37.64 |
| 45as25 | 86.85 | 1.25 | 36.90 |
| 45as45 | 89.09 | 1.89 | 37.163 |
| 45as75 | 92.88 | 3.11 | 36.43 |
| 45as110 | 93.19 | 5.78 | 34.35 |

After testing, the optically functional material prepared in this example has Pission ratio of 0.34 and Mohs hardness of 2.2.

Example 4, preparation of a white optically functional material having a blue-green luster comprises the following steps:

\textcircled{1} preparing a monodisperse polystyrene microsphere emulsion with a diameter of 215 nm and a solid content of 5% by emulsion polymerization. The specific preparation method was:

a. weighing 0.58 g of sodium dodecyl sulfate and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microsphere had a diameter of 215 nm and PDI of 0.02;

\textcircled{2} compounding distilled water with the monodisperse polystyrene microsphere emulsion and anhydrous ethanol by a volume ratio of 1:6:2, proceeding ultrasonic dispersion for 10 minutes, and a homogeneously mixed white nano-microsphere emulsion solution was obtained;

\textcircled{3} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting white hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 4.

TABLE 4

| Test Angle | L* | a* | b* |
|---|---|---|---|
| 45as-15 | 130.70 | 11.04 | −29.56 |
| 45as15 | 96.46 | 6.27 | −14.64 |
| 45as25 | 91.54 | 2.34 | 0.12 |
| 45as45 | 92.49 | 0.86 | 8.41 |
| 45as75 | 96.88 | −3.69 | 12.16 |
| 45as110 | 96.55 | −4.21 | 8.08 |

After testing, the optically functional material prepared in this example has Pission ratio of 0.35 and Mohs hardness of 2.1.

Example 5, preparation of an orange-hued optically functional material having a blue-green luster comprises the following steps:

\textcircled{1} compounding homogeneously mixed magenta nano-microsphere emulsion solution obtained in Example 1 with homogeneously mixed yellow nano-microsphere emulsion solution obtained in Example 3 by a volume ratio of 1:1, proceeding ultrasonic dispersion for 10 minutes, and a homogeneously mixed orange-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting orange hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 5.

TABLE 5

| Test Angle | L* | a* | b* |
|---|---|---|---|
| 45as-15 | 128.10 | −39.78 | 51.48 |
| 45as15 | 112.94 | −9.48 | 60.71 |
| 45as25 | 85.03 | 13.56 | 37.23 |
| 45as45 | 63.94 | 34.60 | 13.23 |
| 45as75 | 66.55 | 40.47 | 11.14 |
| 45as110 | 68.71 | 42.23 | 10.14 |

After testing, the optically functional material prepared in this example has Pission ratio of 0.35 and Mohs hardness of 2.0.

Example 6, preparation of a green-hued optically functional material having a blue-green luster comprises the following steps:

\textcircled{1} compounding homogeneously mixed cyan nano-microsphere emulsion solution obtained in Example 2 with homogeneously mixed yellow nano-microsphere emulsion solution obtained in Example 3 by a volume ratio of 1:1, proceeding ultrasonic dispersion for 10 minutes, and a homogeneously mixed green-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting green hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 6.

TABLE 6

| Test Angle | L* | a* | b* |
|---|---|---|---|
| 45as-15 | 69.18 | 6.35 | −36.63 |
| 45as15 | 97.66 | 8.77 | −58.82 |
| 45as25 | 59.45 | −4.87 | −42.90 |
| 45as45 | 50.71 | 0.86 | 8.41 |
| 45as75 | 54.38 | −27.49 | −15.93 |
| 45as110 | 57.07 | −29.95 | −15.88 |

After testing, the optically functional material prepared in this example has Pission ratio of 0.33 and Mohs hardness of 2.2.

Example 7, preparation of an orange-red-hued optically functional material having a blue-green luster comprises the following steps:

\textcircled{1} compounding homogeneously mixed magenta nano-microsphere emulsion solution obtained in Example 1 with homogeneously mixed yellow nano-microsphere emulsion solution obtained in Example 3 by a volume ratio of 3:1, proceeding ultrasonic dispersion for 10 minutes, and a homogeneously mixed orange-red-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting orange-red hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 7.

TABLE 7

| Test Angle | L* | a* | b* |
|---|---|---|---|
| 45as-15 | 128.10 | −39.78 | 51.48 |
| 45as15 | 112.94 | −9.48 | 60.71 |
| 45as25 | 85.03 | 13.56 | 37.23 |
| 45as45 | 63.94 | 34.60 | 13.23 |
| 45as75 | 66.55 | 40.47 | 11.14 |
| 45as110 | 68.71 | 42.23 | 10.14 |

After testing, the optically functional material prepared in this example has Pission ratio of 0.30 and Mohs hardness of 2.4.

Example 8, preparation of a purple-red-hued optically functional material having a blue-green luster comprises the following steps:

\textcircled{1} compounding homogeneously mixed magenta nano-microsphere emulsion solution obtained in Example 1 with homogeneously mixed cyan nano-microsphere emulsion solution obtained in Example 2 by a volume ratio of 1:1, proceeding ultrasonic dispersion for 10 minutes, and a homogeneously mixed orange-red-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting purple-red hue and blue-green luster was formed on the surface of the glass, with a layer thickness of 5 microns. The color and luster parameters thereof were measured by X-rite MA-98 spectrophotometer, and the light source is D65/10°, with the measuring light path shown in FIG. 4, and the data are shown in Table 8.

TABLE 8

| Test Angle | L* | a* | b* |
|---|---|---|---|
| 45as-15 | 96.71 | 16.97 | −41.59 |
| 45as15 | 99.37 | 25.08 | −70.85 |
| 45as25 | 61.03 | 18.19 | −55.42 |
| 45as45 | 40.49 | 10.42 | −40.69 |
| 45as75 | 42.72 | 3.24 | −31.90 |
| 45as110 | 44.73 | 1.85 | −32.20 |

After testing, the optically functional material prepared in this example has Pission ratio of 0.40 and Mohs hardness of 2.6.

Example 9, preparation of a light-red-hued optically functional material having a blue-green luster comprises the following steps:

\textcircled{1} compounding homogeneously mixed magenta nano-microsphere emulsion solution obtained in Example 1 with homogeneously mixed white nano-microsphere emulsion solution obtained in Example 4 by a volume ratio of 2:1, proceeding ultrasonic dispersion for 10 minutes, and a homogeneously mixed light-red-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting light-red hue and blue-green luster was formed on the surface of the glass, with a layer thickness of 5 microns. The color and luster parameters thereof are measured by X-rite MA-98 spectrophotometer, and the light source is D65/10°, with the measuring light path shown in FIG. 4, and the data are shown in Table 9.

TABLE 9

| Test Angle | L* | a* | b* |
|---|---|---|---|
| 45as-15 | 153.81 | 27.22 | −39.80 |
| 45as15 | 73.26 | 53.54 | −14.78 |
| 45as25 | 71.56 | 52.64 | −9.68 |
| 45as45 | 70.35 | 51.62 | −2.04 |
| 45as75 | 74.67 | 49.17 | 0.43 |
| 45as110 | 71.03 | 42.41 | −1.78 |

After testing, the optically functional material prepared in this example has Pission ratio of 0.40 and Mohs hardness of 2.2.

Example 10, preparation of a yellow-hued optically functional material having an orange-red luster comprises the following steps:

\textcircled{1} weighing 0.30 g of acid yellow 9 and dissolving in 20 ml of deionized water, proceeding ultrasonic dispersion for 20 minutes; compounding a yellow dye solution with a commercially available monodisperse polystyrene microsphere emulsion (with a diameter of 251 nm, and solid content of 10% wt, PDI=0.1) and anhydrous ethanol by a volume ratio of 1:3:2, proceeding ultrasonic dispersion for 10 minutes, and a homogeneously mixed yellow nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting yellow hue and orange-red luster was formed on the surface of the glass, with a layer thickness of 8 microns.

After testing, the optically functional material prepared in this example has Pission ratio of 0.33 and Mohs hardness of 2.0.

Example 11, preparation of a magenta optically functional material having an orange-red luster comprises the following steps:

\textcircled{1} preparing a monodisperse polystyrene microsphere emulsion with a diameter of 252 nm and a solid content of 10% by emulsion polymerization. The specific preparation method was:

a. weighing 0.5 g of sodium dodecyl sulfate and dissolving in 90 ml of deionized water, stirring in a 250 ml three-mouth flask at 300 r/min, and introducing nitrogen and bubbling for 30 min;

b. after water-bath heated to 85° C. and stabilized, adding 10.5 g of styrene monomer;

c. after 15 min, adding 0.10 g of potassium persulfate and reacting at 85° C. for 8 hours under stirring and nitrogen protection, the obtained polystyrene nano-microspheres had a diameter of 252 nm and PDI of 0.01;

\textcircled{2} weighing 0.4 g of acid red 36 and dissolving in 20 ml of deionized water, proceeding ultrasonic dispersion for 20 minutes; compounding a red dye solution with a monodisperse polystyrene microsphere emulsion and anhydrous ethanol by a volume ratio of 1:3:2, proceeding ultrasonic dispersion for 10 minutes, and a homogeneously mixed magenta nano-microsphere emulsion solution was obtained;

\textcircled{3} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting magenta hue and orange-red luster was formed on the surface of the glass, with a layer thickness of 8 microns.

After testing, the optically functional material prepared in this example has Pission ratio of 0.37 and Mohs hardness of 2.1.

Example 12, preparation of an orange-yellow-hued optically functional material having an orange-red luster comprises the following steps:

\textcircled{1} compounding a homogeneous mixture of yellow nano-microsphere emulsion solution obtained in Example 10 with a homogeneous mixture of magenta nano-microsphere emulsion solution obtained in Example 11 by a volume ratio of 2:1, proceeding ultrasonic dispersion for 10 minutes, and a homogeneously mixed orange-yellow-hued nano-microsphere emulsion solution was obtained.

\textcircled{2} placing a cleaned glass sheet of 2.5cm×2.5cm on a heat carrier at 75° C.; after the temperature was stabilized, dropping 1 ml of the mixed solution on the glass sheet to spread evenly; after evaporation of the solvent, a bright and beautiful layer of photonic crystal coating presenting orange-yellow hue and orange-red luster was formed on the surface of the glass, with a layer thickness of 8 microns.

After testing, the optically functional material prepared in this example has Pission ratio of 0.35 and Mohs hardness of 2.1.

Example 13, preparation of a light-red-hued optically functional material having a blue-green luster comprises the following steps:

\textcircled{1} weighing 0.20 g of basic fuchsin 14 and dissolving in 20 ml of deionized water, proceeding ultrasonic dispersion for 20 minutes; compounding a magenta dye solution with a commercially available monodisperse silica ball emulsion (with a diameter of 195 nm, solid content of 10% wt, PDI=0.2) and anhydrous ethanol by a volume ratio of 1:3:2, proceeding ultrasonic dispersion for 10 minutes, and a homogeneously mixed magenta nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting magenta hue and blue-green luster was formed on the surface of the glass, with a layer thickness of 5 microns.

After testing, the optically functional material prepared in this example has Pission ratio of 0.16 and Mohs hardness of 3.1.

Example 14, preparation of a blue-hued optically functional material having a blue-green luster comprises the following steps:

\textcircled{1} weighing 0.10 g of methylene blue and dissolving in 20 ml of deionized water, proceeding ultrasonic dispersion for 20 minutes; compounding a methylene blue dye solution with a commercially available monodisperse silica ball emulsion (with a diameter of 195 nm, solid content of 10% wt, PDI=0.2) and anhydrous ethanol by a volume ratio of 1:3:2, proceeding ultrasonic dispersion for 10 minutes, and a homogeneously mixed blue nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting reddish-blue hue and blue-green luster was formed on the surface of the glass, with a layer thickness of 5 microns.

After testing, the optically functional material prepared in this example has Pission ratio of 0.15 and Mohs hardness of 3.0.

Example 15, preparation of a purple-red-hued optically functional material having a blue-green luster comprises the following steps:

\textcircled{1} compounding homogeneously mixed magenta nano-microsphere emulsion solution obtained in Example 13 with homogeneously mixed blue nano-microsphere emulsion solution obtained in Example 14 by a volume ratio of 1:1, proceeding ultrasonic dispersion for 10 minutes, and a homogeneously mixed purple-red-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting purple-red hue and blue-green luster was formed on the surface of the glass, with a layer thickness of 5 microns.

After testing, the optically functional material prepared in this example has Pission ratio of 0.16 and Mohs hardness of 3.1.

Example 16, preparation of a purple-red-hued optically functional material having a yellow-green luster comprises the following steps:

\textcircled{1} weighing 0.1 g of acid red 60 and 0.1 g of acid blue 5, and dissolving in 20 ml of deionized water, proceeding ultrasonic dispersion for 20 minutes; compounding the mixed dye solution with a commercially available monodisperse polystyrene/polyacrylic acid/ polymethyl methacrylate copolymer emulsion microspheres (with a diameter of 235 nm, solid content of 10% wt, PDI=0.2) and anhydrous ethanol by a volume ratio of 1:3:2, proceeding ultrasonic dispersion for 10 minutes, and a homogeneously mixed purple-red nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting purple-red hue and yellow-green luster was formed on the surface of the glass, with a layer thickness of 6 microns.

After testing, the optically functional material prepared in this example has Pission ratio of 0.42 and Mohs hardness of 2.4.

Example 17, preparation of a purple-red-hued optically functional material having a red luster comprises the following steps:

\textcircled{1} weighing 0.1 g of basic magenta 14 and 0.05 g of methylene blue, and dissolving in 20 ml of deionized water, proceeding ultrasonic dispersion for 20 minutes; compounding the mixed dye solution with a commercially available monodisperse ferroferric oxide microspheres (with a diameter of 185 nm, solid content of 6% wt, PDI=0.3) and anhydrous ethanol by a volume ratio of 1:6:2, proceeding ultrasonic dispersion for 10 minutes, and a homogeneously mixed purple-red nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting purple-red hue and red luster was formed on the surface of the glass, with a layer thickness of 6 microns.

After testing, the optically functional material prepared in this example has Pission ratio of 0.10 and Mohs hardness of 3.5.

Example 18, preparation of a purple-red-hued optically functional material having an orange-red luster comprises the following steps:

\textcircled{1} weighing 0.1 g of basic red 14 and 0.05 g of methylene blue, and dissolving in 20 ml of deionized water, proceeding ultrasonic dispersion for 20 minutes; compounding the mixed dye solution with a commercially available monodisperse ferric aluminum oxide microspheres (with a diameter of 195 nm, solid content of 6% wt, PDI=0.33) and anhydrous ethanol by a volume ratio of 1:6:2, proceeding ultrasonic dispersion for 10 minutes, and a homogeneously mixed purple-red nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting purple-red hue and orange-red luster was formed on the surface of the glass, with a layer thickness of 6 microns.

After testing, the optically functional material prepared in this example has Pission ratio of 0.12 and Mohs hardness of 3.4.

Example 19, preparation of a purple-red-hued optically functional material having a gold-red luster comprises the following steps:

\textcircled{1} weighing 0.1 g of basic red 14 and 0.05 g of methylene blue, and dissolving in 20 ml of deionized water, proceeding ultrasonic dispersion for 20 minutes; compounding the mixed dye solution with a commercially available monodisperse zirconia emulsion microspheres (with a diameter of 178 nm, solid content of 6% wt, PDI=0.28) and anhydrous ethanol by a volume ratio of 1:6:2, proceeding ultrasonic dispersion for 10 minutes, and a homogeneously mixed purple-red nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting purple-red hue and gold-red luster was formed on the surface of the glass, with a layer thickness of 6 microns.

After testing, the optically functional material prepared in this example has Pission ratio of 0.14 and Mohs hardness of 3.4.

Example 20, preparation of a blue-hued optically functional material having a gold-red luster comprises the following steps:

\textcircled{1} weighing 0.5 g of methylene blue and dissolving in 20 ml of deionized water, proceeding ultrasonic dispersion for 20 minutes; compounding the mixed dye solution with a commercially available monodisperse titanium dioxide emulsion microspheres (with a diameter of 183 nm, solid content of 6% wt, PDI=0.28) and anhydrous ethanol by a volume ratio of 1:6:2, proceeding ultrasonic dispersion for 10 minutes, and a homogeneously mixed blue-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting blue hue and gold-red luster was formed on the surface of the glass, with a layer thickness of 6 microns.

After testing, the optically functional material prepared in this example has Pission ratio of 0.10 and Mohs hardness of 3.6.

Example 21, preparation of a reddish-brown-hued optically functional material having a purple-red luster comprises the following steps:

\textcircled{1} compounding a commercially available monodisperse phenolic resin emulsion microspheres (with a diameter of 270 nm, solid content of 2% wt, PDI=0.4) and anhydrous ethanol by a volume ratio of 6:1, proceeding ultrasonic dispersion for 10 minutes, and a homogeneously mixed reddish-brown-hued nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting reddish-brown hue and purple-red luster was formed on the surface of the glass, with a layer thickness of 4 microns.

After testing, the optically functional material prepared in this example has Pission ratio of 0.18 and Mohs hardness of 4.1.

Example 22, preparation of a yellow-hued optically functional material having an orange-red luster comprises the following steps:

\textcircled{1} weighing 0.30 g of acid yellow 9 and dissolving in 20 ml of deionized water, proceeding ultrasonic dispersion for 20 minutes; compounding the yellow dye solution with a commercially available monodisperse polystyrene microsphere emulsion (with a diameter of 251 nm, solid content of 10% wt, PDI=0.1) and ethylene glycol by a volume ratio of 1:3:2, proceeding ultrasonic dispersion for 10 minutes, and a homogeneously mixed yellow nano-microsphere emulsion solution was obtained;

\textcircled{2} placing a cleaned glass sheet of 2.5 cm×2.5 cm on a heat carrier at 75° C.; after the temperature was stabilized, dropping 6 ml of the mixed solution on the glass sheet to spread evenly; after evaporation of the solvent, a bright and beautiful layer of photonic crystal coating presenting yellow hue and orange-red luster was formed on the surface of the glass, with a layer thickness of 40 microns.

After testing, the optically functional material prepared in this example has Pission ratio of 0.35 and Mohs hardness of 2.2.

Example 23, preparation of a yellow-hued optically functional material having an orange-red luster comprises the following steps:

\textcircled{1} weighing 0.30 g of acid yellow 9 and dissolving in 20 ml of deionized water, proceeding ultrasonic dispersion for 20 minutes; compounding the yellow dye solution with a commercially available monodisperse polystyrene microsphere emulsion (with a diameter of 251 nm, solid content of 10% wt, PDI=0.1) and acetone by a volume ratio of 1:3:2, proceeding ultrasonic dispersion for 10 minutes, and a homogeneously mixed yellow nano-microsphere emulsion solution was obtained;

\textcircled{2} placing a cleaned glass sheet of 2.5 cm×2.5 cm on a heat carrier at 75° C.; after the temperature was stabilized, dropping 0.3 ml of the mixed solution on the glass sheet to spread evenly; after evaporation of the solvent, a bright and beautiful layer of photonic crystal coating presenting yellow hue and orange-red luster was formed on the surface of the glass, with a layer thickness of 2 microns.

After testing, the optically functional material prepared in this example has Pission ratio of 0.37 and Mohs hardness of 2.2.

Example 24, preparation of a red-hued optically functional material having a cyan-green luster comprises the following steps:

\textcircled{1} preparing a monodisperse polystyrene microsphere emulsion with a diameter of 210 nm and a solid content of 5% by emulsion polymerization. The specific preparation method was:

a. weighing 0.58 g of sodium dodecyl sulfate and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microspheres had a diameter of 210 nm and PDI of 0.002;

\textcircled{2} placing a cleaned glass sheet of 2.5 cm×2.5 cm on a heat carrier at 75° C.; after the temperature was stabilized, dropping 1 ml of the polystyrene microsphere emulsion obtained in step CD on the glass sheet to spread evenly; after evaporation of the solvent, a bright and beautiful layer of photonic crystal coating presenting blue-green luster was formed on the surface of the glass;

\textcircled{3} weighing 0.18 g of rhodamine 6G and dissolving in 20 ml of polyurethane resin, stirring and dispersing, dropping the red resin on the photonic crystal coating for penetrating into the gaps of the microspheres, after evaporation of the solvent, a layer of homogeneously filled functional film presenting red hue and blue-green luster was formed, with a layer thickness of 5 microns. The color and luster parameters thereof were measured by X-rite MA-98 spectrophotometer, and the light source is D65/10°, with the measuring light path shown in FIG. 4, and the data are shown in Table 10.

TABLE 10

| Test Angle | L* | a* | b* |
|---|---|---|---|
| 45as-15 | 51.58 | 3.24 | −45.63 |
| 45as15 | 127.46 | 4.57 | −53.16 |
| 45as25 | 83.17 | 1.96 | −53.79 |
| 45as45 | 51.25 | 1.64 | −59.23 |
| 45as75 | 52.89 | 5.93 | −51.94 |
| 45as110 | 56.53 | −8.57 | −53.52 |

After testing, the optically functional material prepared in this example has Pission ratio of 0.45 and Mohs hardness of 2.0.

Example 25, preparation of a purple-hued optically functional material having a red luster comprises the following steps:

taking commercially available polystyrene monodisperse microspheres (particle size 280 nm, PDI<0.005) with a solid content of 5%, placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting red luster was formed on the surface of the glass,

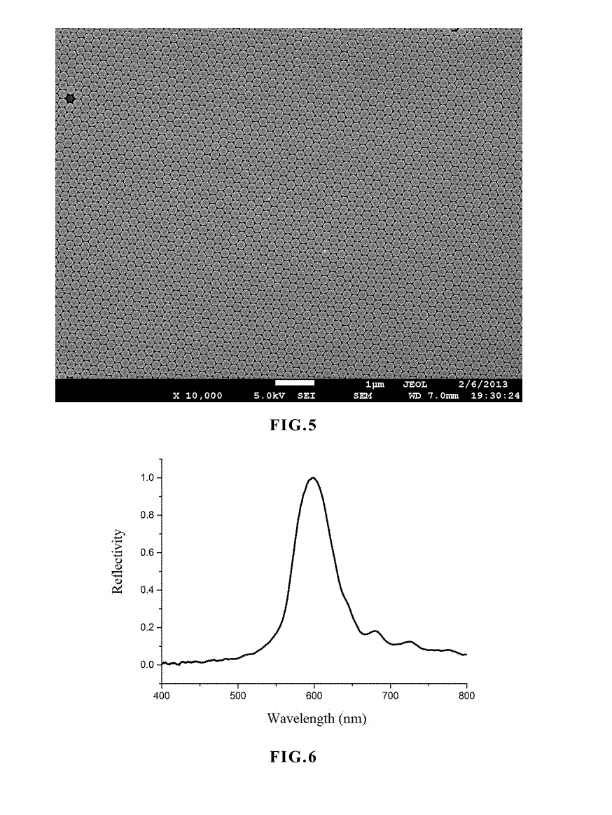

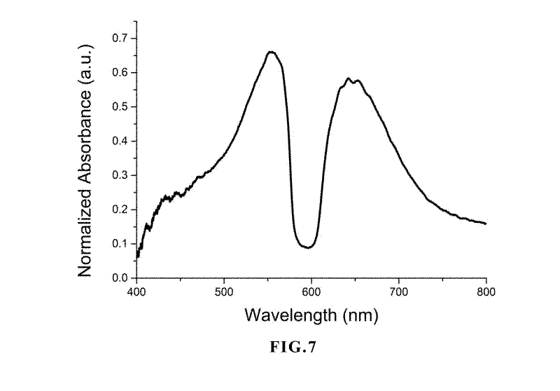

weighing 0.18 g of methyl blue and dissolving in 20 ml of polyurethane resin, stirring and dispersing, coating the blue resin by using a coating machine on the photonic crystal coating for penetrating into the gaps of the microspheres, after evaporation of the solvent, a layer of homogeneously filled functional film presenting purple hue and red luster was formed, with a layer thickness of 5 microns. The color and luster parameters thereof were measured by X-rite MA-98 spectrophotometer, and the light source is D65/10°, with the measuring light path shown in FIG. 4, and the data are shown in Table 11. The SEM photograph of the polystyrene emulsion microspheres after assembly is shown in FIG. 5, the reflectance spectrum of the polystyrene emulsion microspheres is shown in FIG. 6, corresponding to its luster, and the absorption spectrum is shown in FIG. 7, corresponding to its hue,

TABLE 11

| Test Angle | L* | a* | b* |
|---|---|---|---|
| 45as-15 | 96.71 | 16.97 | −41.59 |
| 45as15 | 99.37 | 25.08 | −70.85 |
| 45as25 | 61.03 | 18.19 | −55.42 |
| 45as45 | 40.49 | 10.42 | −40.69 |
| 45as75 | 42.72 | 3.24 | −31.90 |
| 45as110 | 44.73 | 1.85 | −32.20 |

After testing, the optically functional material prepared in this example has Pission ratio of 0.52 and Mohs hardness of 1.9.

Example 26, preparation of a yellow-hued optically functional material having a green luster comprises the following steps:

taking commercially available silica monodisperse microspheres (particle size 192 nm, PDI<0.005) with a solid content of 5%, placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting green luster was formed on the surface of the glass,

weighing 0.18 g of lemon yellow and dissolving in 20 ml of silicon resin, stirring and dispersing, coating the yellow resin by using a spraying equipment on the photonic crystal coating for penetrating into the gaps of the microspheres, after evaporation of the solvent, a layer of homogeneously filled functional film presenting yellow hue and green luster was formed, with a layer thickness of 5 microns. The color and luster parameters thereof were measured by X-rite MA-98 spectrophotometer, and the light source is D65/10°, with the measuring light path shown in FIG. 4, and the data are shown in Table 12.

TABLE 12

| Test Angle | L* | a* | b* |
|---|---|---|---|
| 45as-15 | 114.92 | −14.80 | 58.19 |
| 45as15 | 87.48 | 1.25 | 37.64 |
| 45as25 | 86.85 | 1.25 | 36.90 |
| 45as45 | 89.09 | 1.89 | 37.163 |
| 45as75 | 92.88 | 3.11 | 36.43 |
| 45as110 | 93.19 | 5.78 | 34.35 |

After testing, the optically functional material prepared in this example has Pission ratio of 0.22 and Mohs hardness of 2.7.

Example 27, preparation of an orange-yellow-hued optically functional material having a blue-green luster comprises the following steps:

taking commercially available polystyrene monodisperse microspheres (particle size 170 nm, PDI<0.005) with a solid content of 5%, placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting green luster was formed on the surface of the glass,

weighing 0.18 g of lemon yellow and 0.2 g of rhodamine 6G and dissolving in 20 ml of ethanol solution of ethyl orthosilicate, stirring and dispersing, coating the orange-yellow resin by using a spraying equipment on the photonic crystal coating for penetrating into the gaps of the microspheres, after evaporation of the solvent, a layer of homogeneously filled functional film presenting orange-yellow hue and green luster was formed, with a layer thickness of 5 microns. The color and luster parameters thereof were measured by X-rite MA-98 spectrophotometer, and the light source is D65/10°, with the measuring light path shown in FIG. 4, and the data are shown in Table 13.

TABLE 13

| Test Angle | L* | a* | b* |
|---|---|---|---|
| 45as-15 | 128.10 | −39.78 | 51.48 |
| 45as15 | 112.94 | −9.48 | 60.71 |
| 45as25 | 85.03 | 13.56 | 37.23 |
| 45as45 | 63.94 | 34.60 | 13.23 |
| 45as75 | 66.55 | 40.47 | 11.14 |
| 45as110 | 68.71 | 42.23 | 10.14 |

After testing, the optically functional material prepared in this example has Pission ratio of 0.48 and Mohs hardness of 1.9.

Example 28, preparation of a red-hued optically functional material having a blue-green luster comprises the following steps:

taking commercially available poly(zirconium oxide) monodisperse microspheres (particle size 70 nm, PDI<0.005) with a solid content of 5%, placing the cleaned glass sheet of 2.5 cm×2.5 cm on the heat carrier at 75° C.; after the temperature was stabilized, dropping 1 ml of the mixed solution on the glass sheet to spread evenly; after evaporation of the solvent, a bright and beautiful layer of photonic crystal coating presenting green luster was formed on the surface of the glass,

weighing 1 g of red acrylic resin masterbatch and dissolving in 8 g of acrylic resin, dispersing homogeneously, coating the red resin by using a coating machine on the photonic crystal coating for penetrating into the gaps of the microspheres, after evaporation of the solvent, a layer of homogeneously filled functional film presenting red hue and blue-green luster was formed, with a layer thickness of 5 microns. The color and luster parameters thereof were measured by X-rite MA-98 spectrophotometer, and the light source is D65/10°, with the measuring light path shown in FIG. 4, and the data are shown in Table 14.

TABLE 14

| Test Angle | L* | a* | b* |
|---|---|---|---|
| 45as-15 | 153.81 | 27.22 | −39.80 |
| 45as15 | 73.26 | 53.54 | −14.78 |
| 45as25 | 71.56 | 52.64 | −9.68 |
| 45as45 | 70.35 | 51.62 | −2.04 |
| 45as75 | 74.67 | 49.17 | 0.43 |
| 45as110 | 71.03 | 42.41 | −1.78 |

After testing, the optically functional material prepared in this example has Pission ratio of 0.20 and Mohs hardness of 3.0.

Example 29, preparation of an orange optically functional material having a green luster comprises the following steps:

taking commercially available aluminum oxide monodisperse microspheres (particle size 142 nm, PDI<0.1) with a solid content of 5%, placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting green luster was formed on the surface of the glass,

weighing 1 g of orange epoxy resin masterbatch and dissolving in 10 g of epoxy resin, dispersing homogeneously, coating the orange resin by using a coating machine on the photonic crystal coating for penetrating into the gaps of the microspheres, after evaporation of the solvent, a layer of homogeneously filled functional film presenting orange hue and green luster was formed, with a layer thickness of 5 microns.

After testing, the optically functional material prepared in this example has Pission ratio of 0.21 and Mohs hardness of 3.1.

Example 30, preparation of a blue-purple hued optically functional material having a purple-red luster comprises the following steps:

taking commercially available monodisperse phenolic resin microspheres (particle size 275 nm, PDI<0.1) with a solid content of 5%, placing a cleaned glass sheet of 2.5 cm×2.5 cm on a heat carrier at 75° C.; after the temperature was stabilized, dropping 5 ml of the mixed solution on the glass sheet to spread evenly; after evaporation of the solvent, a bright and beautiful layer of photonic crystal coating presenting purple-red luster was formed on the surface of the glass,

weighing 1 g of blue epoxy resin masterbatch and dissolving in 10 g of epoxy resin, dispersing homogeneously, coating the blue resin by using a coating machine on the photonic crystal coating for penetrating into the gaps of the microspheres, after evaporation of the solvent, a layer of homogeneously filled functional film presenting blue-purple hue and purple-red luster was formed, with a layer thickness of 20 microns.

After testing, the optically functional material prepared in this example has Pission ratio of 0.24 and Mohs hardness of 3.5.

Example 31, preparation of a green-hued optically functional material having a gold-red luster comprises the following steps:

taking commercially available monodisperse titanium dioxide microspheres (particle size 135 nm, PDI<0.2) with a solid content of 5%, and placing a cleaned glass sheet of 2.5 cm×2.5 cm on a heat carrier at 75° C.; after the temperature was stabilized, dropping 0.5 ml of the mixed solution on the glass sheet to spread evenly; after evaporation of the solvent, a bright and beautiful layer of photonic crystal coating presenting gold-red luster was formed on the surface of the glass,

weighing 0.2 g of green epoxy resin masterbatch and dissolving in 3 g of epoxy resin, dispersing homogeneously, coating the green resin by using a coating machine on the photonic crystal coating for penetrating into the gaps of the microspheres, after evaporation of the solvent, a layer of homogeneously filled functional film presenting green hue and gold-red luster was formed, with a layer thickness of 2 microns.

After testing, the optically functional material prepared in this example has Pission ratio of 0.19 and Mohs hardness of 3.2.

Example 32, preparation of a dull-green-hued optically functional material having a red luster comprises the following steps:

taking commercially available monodisperse ferroferric oxide microspheres (particle size 140 nm, PDI<0.2) with a solid content of 5%, and placing a cleaned glass sheet of 2.5 cm×2.5 cm on a heat carrier at 75° C.; after the temperature was stabilized, dropping 0.5 ml of the mixed solution on the glass sheet to spread evenly; after evaporation of the solvent, a bright and beautiful layer of photonic crystal coating presenting red luster was formed on the surface of the glass,

weighing 0.2 g of green polyurethane resin masterbatch and dissolving in 3 g of epoxy resin, dispersing homogeneously, coating the green resin by using a coating machine on the photonic crystal coating for penetrating into the gaps of the microspheres, after evaporation of the solvent, a layer of homogeneously filled functional film presenting dull-green hue and gold-red luster was formed, with a layer thickness of 2 microns.

After testing, the optically functional material prepared in this example has Pission ratio of 0.18 and Mohs hardness of 2.9.

Example 33, preparation of an orange optically functional material having a green luster comprises the following steps:

taking commercially available monodisperse fluorescein polystyrene microspheres (particle size 172 nm, PDI<0.005) with a solid content of 5%, and placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a bright and beautiful layer of photonic crystal coating presenting green luster was formed on the surface of the glass,

weighing 1 g of red epoxy resin masterbatch and dissolving in 10 g of epoxy resin, dispersing homogeneously, coating the magenta resin by using a coating machine on the photonic crystal coating for penetrating into the gaps of the microspheres, after evaporation of the solvent, a layer of homogeneously filled functional film presenting orange hue and green luster was formed, with a layer thickness of 5 microns. The color and luster parameters can be determined by X-rite MA-98 spectrophotometer.

After testing, the optically functional material prepared in this example has Pission ratio of 0.60 and Mohs hardness of 1.9.

Example 34, preparation of a black optically functional material having a blue-green luster comprises the following steps:

\textcircled{1} compounding homogeneously mixed magenta nano-microsphere emulsion solution obtained in Example 1 with homogeneously mixed cyan nano-microsphere emulsion solution obtained in Example 2 and homogeneously mixed yellow nano-microsphere emulsion solution obtained in Example 3 by a volume ratio of 1:1.7:0.8, proceeding ultrasonic dispersion for 10 minutes, and a homogeneous mixture of black nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a layer of black photonic crystal coating presenting blue-green luster was formed on the surface of the glass, with a layer thickness of 5 microns.

After testing, the optically functional material prepared in this example has Pission ratio of 0.35 and Mohs hardness of 2.2.

Example 35, preparation of a grey optically functional material having a blue-green luster comprises the following steps:

\textcircled{1} compounding the homogeneously mixed black nano-microsphere emulsion solution obtained in Example 34 and the white nano-microsphere emulsion solution obtained in Example 4 by a volume ratio of 1:1, proceeding ultrasonic dispersion for 10 minutes, and a homogeneously mixed grey nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a layer of grey photonic crystal coating presenting blue-green luster was formed on the surface of the glass, with a layer thickness of 5 microns.

After testing, the optically functional material prepared in this example has Pission ratio of 0.36 and Mohs hardness of 2.3.

Example 36, preparation of a dark-red optically functional material having a blue-green luster comprises the following steps:

\textcircled{1} compounding the homogeneously mixed black nano-microsphere emulsion solution obtained in Example 34 with the magenta nano-microsphere emulsion solution obtained in Example 1 by a volume ratio of 1:1, proceeding ultrasonic dispersion for 10 minutes, and a homogeneously mixed dark-red nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a layer of dark-red photonic crystal coating presenting blue-green luster was formed on the surface of the glass, with a layer thickness of 5 microns.

After testing, the optically functional material prepared in this example has Pission ratio of 0.45 and Mohs hardness of 2.1.

Example 37, preparation of a dull-red optically functional material having a blue-green luster comprises the following steps:

\textcircled{1} compounding the homogeneously mixed black nano-microsphere emulsion solution obtained in Example 34 with the magenta nano-microsphere emulsion solution obtained in Example 1 by a volume ratio of 1:1, proceeding ultrasonic dispersion for 10 minutes, and a homogeneously mixed dull-red nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a layer of dull-red photonic crystal coating presenting blue-green luster was formed on the surface of the glass, with a layer thickness of 5 microns.

After testing, the optically functional material prepared in this example has Pission ratio of 0.40 and Mohs hardness of 2.4.

Example 38, preparation of a dark-grey optically functional material having a blue-green luster comprises the following steps:

\textcircled{1} compounding the homogeneously mixed black nano-microsphere emulsion solution obtained in Example 34 with the grey nano-microsphere emulsion solution obtained in Example 35 by a volume ratio of 1:1, proceeding ultrasonic dispersion for 10 minutes, and a homogeneously mixed grey nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed solution on the glass sheet to spread evenly; after evaporation of the solvent, a layer of dark grey photonic crystal coating presenting blue-green luster was formed on the surface of the glass, with a layer thickness of 5 microns.

After testing, the optically functional material prepared in this example has Pission ratio of 0.48 and Mohs hardness of 2.6.

Example 39, preparation of a magenta optically functional material having specific ultraviolet reflection comprises the following steps:

\textcircled{1} preparing a monodisperse polystyrene microsphere emulsion with a diameter of 165 nm and a solid content of 5% by emulsion polymerization. The specific preparation method was:

a. weighing 0.98 g of sodium dodecyl sulfate and 0.2 g rhodamine 6G, and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microspheres had a diameter of 165 nm and PDI of 0.03;

\textcircled{2} compounding a magenta monodisperse polystyrene microsphere emulsion with anhydrous ethanol by a volume ratio of 7:2, proceeding ultrasonic dispersion for 10 minutes, and a homogeneously mixed magenta nano-microsphere emulsion solution was obtained;

\textcircled{3} placing a cleaned glass sheet of 2.5 cm×2.5 cm on a heat carrier at 75° C.; after the temperature was stabilized, dropping 1 ml of the homogeneously mixed magenta nano-microsphere emulsion solution obtained in step \textcircled{2} on the glass sheet to spread evenly; after evaporation of the solvent, a bright and beautiful layer of photonic crystal coating presenting magenta hue was formed on the surface of the glass, with a layer thickness of 5 microns. The band-gap was measured by an optical fiber spectroscopy to be in the near ultraviolet region with a peak of 280 nm.

After testing, the optically functional material prepared in this example has Pission ratio of 0.50 and Mohs hardness of 2.8.

Example 40, preparation of a magenta optically functional material having specific infrared reflection comprises the following steps:

\textcircled{1} preparing a monodisperse polystyrene microsphere emulsion with a diameter of 365 nm and a solid content of 5% by emulsion polymerization. The specific preparation method was:

a. weighing 0.28 g of sodium dodecyl sulfate and 0.2 g rhodamine 6G, and dissolving in 90 ml of deionized water, stirring in a 250 ml three-mouth flask at 300 r/min, and introducing nitrogen and bubbling for 30 min;

b. after water-bath heated to 85° C. and stabilized, adding 5 g of styrene monomer;

c. after 15 min, adding 0.10 g of potassium persulfate and reacting at 85° C. for 5 hours under stirring and nitrogen protection, the obtained polystyrene nano-microspheres had a diameter of 365 nm and PDI of 0.015;

\textcircled{2} compounding a magenta monodisperse polystyrene microsphere emulsion and anhydrous ethanol by a volume ratio of 7:2, proceeding ultrasonic dispersion for 10 minutes, and a homogeneously mixed magenta nano-microsphere emulsion solution was obtained.

\textcircled{3} placing a cleaned glass sheet of 2.5 cm×2.5 cm on a heat carrier at 75° C.; after the temperature was stabilized, dropping 1 ml of the homogeneously mixed magenta nano-microsphere emulsion solution obtained in step \textcircled{2} on the glass sheet to spread evenly; after evaporation of the solvent, a bright and beautiful layer of photonic crystal coating presenting magenta hue was formed on the surface of the glass, with a layer thickness of 5 microns. The band-gap is measured by an optical fiber spectroscopy to be in the infrared region with a peak of 1100 nm.

After testing, the optically functional material prepared in this example has Pission ratio of 0.41 and Mohs hardness of 2.4.

Example 41, preparation of a purple-red optically functional material having a blue-green luster comprises the following steps:

\textcircled{1} taking the bright and beautiful layer of photonic crystal coating presenting magenta hue and blue-green luster obtained in Example 1, with a thickness of 5 microns;

\textcircled{2} then weighing 0.1 g of methylene blue and dissolving in 20 ml of polyurethane resin, stirring and dispersing, dropping the blue resin on the photonic crystal coating for penetrating into the gaps of the microspheres, after evaporation of the solvent and curing of the resin, a layer of homogeneously filled functional film presenting purple-red hue and blue-green luster was formed, with a layer thickness of 5 microns.

After testing, the optically functional material prepared in this example has Pission ratio of 0.35 and Mohs hardness of 2.2.

Example 42, preparation of a light-green optically functional material having a blue-green luster comprises the following steps:

\textcircled{1} compounding the homogeneously mixed yellow nano-microsphere emulsion solution obtained in Example 3 with the white nano-microsphere emulsion solution obtained in Example 4 by a volume ratio of 3:1, and a light-yellow nano-microsphere emulsion solution was obtained;

\textcircled{2} then weighing 0.1 g of methylene blue and dissolving in 20 ml of water-based polyurethane resin, stirring and dispersing, compounding the blue resin with the light-yellow nano-microsphere emulsion solution obtained in the above step by a volume ratio of 2:8, stirring and dispersing, proceeding ultrasonic dispersion for 30 minutes, and a sticky light-green emulsion was obtained;

\textcircled{3} placing a cleaned glass sheet of 2.5 cm×2.5 cm on a heat carrier at 95° C.; after the temperature was stabilized, dropping 1 ml of the mixed emulsion on the glass sheet to spread evenly; after evaporation of the solvent, a bright and beautiful layer of photonic crystal coating presenting light-green hue and blue-green luster was formed on the surface of the glass, with a layer thickness of 5 microns.

After testing, the optically functional material prepared in this example has Pission ratio of 0.39 and Mohs hardness of 2.7.

Example 43, preparation of a light-red optically functional material having a blue-green luster comprises the following steps:

\textcircled{1} weighing 0.20 g of basic magenta 14 and dissolving in 20 ml of deionized water, proceeding ultrasonic dissolution for 20 minutes, compounding the magenta dye solution with commercially available monodisperse polyimide emulsion (polyimide microsphere has a particle diameter of 215 nm, solid content of 10% wt, PDI=0.2) and anhydrous ethanol by a volume ratio of 1:3:2, proceeding ultrasonic dispersion for 10 minutes, and a homogeneously mixed magenta nano-microsphere emulsion solution was obtained;

\textcircled{2} placing a cleaned glass sheet of 2.5 cm×2.5 cm on a heat carrier at 75° C.; after the temperature was stabilized, dropping 1 ml of the mixed emulsion on the glass sheet to spread evenly; after evaporation of the solvent, a bright and beautiful layer of photonic crystal coating presenting magenta hue and blue-green luster was formed on the surface of the glass, with a layer thickness of 5 microns.

After testing, the optically functional material prepared in this example has Pission ratio of 0.45 and Mohs hardness of 2.4.

Example 44, preparation of a light-red-hued optically functional material having a blue-green luster comprises the following steps:

\textcircled{1} weighing 0.20 g of acid red 14 and dissolving in 20 ml of deionized water, proceeding ultrasonic dissolution for 20 minutes, compounding the magenta dye solution with commercially available monodisperse silicon resin emulsion (silicon resin microsphere has a particle diameter of 225 nm, solid content of 10% wt, PDI=0.18) and anhydrous ethanol by a volume ratio of 1:3:2, proceeding ultrasonic dispersion for 10 minutes, and a homogeneously mixed magenta nano-microsphere emulsion solution was obtained;

\textcircled{2} placing a cleaned glass sheet of 2.5 cm×2.5 cm on a heat carrier at 85° C.; after the temperature was stabilized, dropping 1 ml of the mixed solution on the glass sheet to spread evenly; after evaporation of the solvent, a bright and beautiful layer of photonic crystal coating presenting magenta hue and blue-green luster was formed on the surface of the glass, with a layer thickness of 5 microns.

After testing, the optically functional material prepared in this example has Pission ratio of 0.42 and Mohs hardness of 2.0.

### Example 45

A layer of photonic crystal coating presenting red luster was prepared according to the steps of the method in Example 25;

0.18 g of methyl blue was weighed and dissolved in 20 ml of polyurethane resin, stirred and dispersed, and the blue resin was coated on the photonic crystal coating by using a coating machine for penetrating into the gaps of the microspheres, after evaporation of the solvent, a layer of homogeneously filled coating was formed, the polystyrene microspheres were etched and removed, and a coating material was obtained.

After testing, the material prepared in this example has Pission ratio of 0.05 and Mohs hardness of 1.9, and both the hue and luster of the material are purple.

### Example 46

A layer of photonic crystal coating presenting purple luster was prepared according to the steps of method in Example 30;

1 g of blue epoxy resin masterbatch was weighed and dissolved in 10 g of epoxy resin, dispersed homogeneously, and the blue resin was coated on the photonic crystal coating by using a coating machine for penetrating into the gaps of the microspheres, after evaporation of the solvent, a layer of homogeneously filled coating was formed, the phenolic resin microspheres were etched and removed, and a coating material was obtained.

After testing, the material prepared in this example has Pission ratio of 0.08 and Mohs hardness of 4.1, and both the hue and luster of the material are purple.

### Example 47

A layer of photonic crystal coating presenting green luster was prepared according to the steps of method in Example 33;

1 g of red epoxy resin masterbatch was weighed and dissolved in 10 g of epoxy resin, dispersed homogeneously, and the magenta resin was coated on the photonic crystal coating by using a coating machine for penetrating into the gaps of the microspheres, after evaporation of the solvent, a layer of homogeneously filled coating was formed, the polystyrene microspheres were etched and removed, and a coating material was obtained.

After testing, the material prepared in this example has Pission ratio of 0.81 and Mohs hardness of 2.4, and both the hue and luster of the material are orange red.

### Example 48

A layer of photonic crystal coating presenting cyan-green luster was prepared according to the steps of method in Example 24;

0.18 g of rhodamine 6G was weighed and dissolved in 20 ml of polyurethane resin, dispersed homogeneously, and the red resin was coated on the photonic crystal coating by using a coating machine for penetrating into the gaps of the microspheres, after evaporation of the solvent, a layer of homogeneously filled coating was formed, the polystyrene microspheres were etched and removed, and a coating material was obtained.

After testing, the material prepared in this example has Pission ratio of 0.70 and Mohs hardness of 1.7, and both the hue and luster of the material are purple.

### Example 49

A layer of photonic crystal coating presenting yellow-green luster was prepared according to the steps of method in Example 16;

0.18 g of rhodamine 6G was weighed and dissolved in 20 ml of polyurethane resin, dispersed homogeneously, and the red resin was coated on the photonic crystal coating by using a coating machine for penetrating into the gaps of the microspheres, after evaporation of the solvent, a layer of homogeneously filled coating was formed, the polystyrene microspheres were etched and removed, and a coating material was obtained.

After testing, the material prepared in this example has Pission ratio of 0.10 and Mohs hardness of 1.8, and both the hue and luster of the material are red.

### Example 50

A layer of photonic crystal coating presenting blue-green luster was prepared according to the steps of method in Example 1;

0.2 g of green polyurethane resin masterbatch was weighed and dissolved in 3 g of epoxy resin, dispersed homogeneously, and the green resin was coated on the photonic crystal coating by using a coating machine for penetrating into the gaps of the microspheres, after evaporation of the solvent, a layer of homogeneously filled coating was formed, the polystyrene microspheres were etched and removed, and a coating material was obtained.

After testing, the material prepared in this example has Pission ratio of 0.24 and Mohs hardness of 4.5, and both the hue and luster of the material are dull green.

The preferred specific embodiments of the present invention have been described in detail above. It is to be understood that numerous modifications and variations can be made by those ordinary skilled in the art in accordance with the concepts of the present invention without any inventive effort. Hence, the technical solutions that may be derived by those skilled in the art according to the concepts of the present invention on the basis of the prior art through logical analysis, reasoning and limited experiments should be within the scope of protection defined by the claims.

1. An optically functional material comprising a nano-microsphere layer formed by periodically arranged nano-microspheres, the nano-microsphere layer being a closely packed structure, so as to provide the optical functional material with luster; wherein the nano-microsphere layer comprises colorless nano-microspheres, white nano-microspheres, gray nano-microspheres, black nano-microspheres or chromatic nano-microspheres.

2. The optically functional material of claim 1, wherein the optically functional material has Poisson ratio ranging from 0.1 to 0.7, and/or, Mohs hardness ranging from 1.9 to 4.1.

3. The optically functional material of claim 1, wherein the nano-microsphere layer comprises a plurality of nano-microspheres of different colors, and the color of each nano-microsphere is selected from white, gray, black or chromatic colors; and/or, the optical functional material is transparent, semitransparent or slightly transparent.

4. The optically functional material of claim 1, wherein the nano-microsphere layer comprises white nano-microspheres and at least one kind of chromatic nano-microspheres; or,
the nano-microsphere layer comprises chromatic nano-microspheres having different hues; or,
the nano-microsphere layer comprises white nano-microspheres, black nano-microspheres and chromatic nano-microspheres; or,
the nano-microsphere layer comprises black nano-microspheres and chromatic nano-microspheres; or,
the nano-microsphere layer comprises gray nano-microspheres and chromatic nano-microspheres; or,
the nano-microsphere layer comprises white nano-microspheres and black nano-microspheres; or,
the nano-microsphere layer comprises gray nano-microspheres and black nano-microspheres.

5. The optically functional material of claim 1, wherein the nano-microsphere is selected from the group consisting of cyan nano-microsphere, magenta nano-microsphere, yellow nano-microsphere and combinations thereof.

6. The optically functional material of claim 1, wherein the color of the nano-microspheres is the color of the nano-microspheres per se or is formed by tinting; and/or, the raw material of the nano-microspheres is selected from the group consisting of polystyrene, polyacrylate, polyacrylic acid, silica, alumina, titania, zirconium oxide, ferroferric oxide, polyimide, silicon resin, and phenolic resin.

7. The optically functional material of claim 1, wherein the monodispersity PDI of the nano-microspheres is less than 0.5; and/or, the nano-microsphere has a particle diameter of 80˜1100 nm.

8. The optically functional material of claim 7, wherein the monodispersity PDI of the nano-microspheres is less than 0.05; and/or, the nano-microsphere has a particle diameter of 120˜400 nm.

9. The optically functional material of claim 1, wherein the nano-microsphere layer forms photonic crystals; and/or, the thickness of the nano-microsphere layer is 1˜50 μm.

10. The optically functional material of claim 1, wherein the nano-microsphere is selected from one or more than two materials with similar refractive indexes, and the refractive index deviation of the materials of the nano-microspheres is less than 2%.

11. The optically functional material of claim 1, wherein the voids between the nano-microspheres are filled with a filling medium.

12. The optically functional material of claim 11, wherein the filling medium is colorless, white, gray, black or chromatic; and/or,
the filling medium is transparent, semitransparent or slightly transparent; and/or,
the filling medium is a gas, a liquid or a solid.

13. The optically functional material of claim 12, wherein the liquid filling medium is selected from the group consisting of silicone oil, mineral oil, vegetable oil and animal oil and fat; and/or,
the solid filling medium is selected from the group consisting of silica, titania, zinc oxide, carbon black, silicon resin, polyurethane resin, epoxy resin, acrylic resin, alkyd resin and polyester.

14. The optically functional material of claim 11, wherein the filling medium contains a colored substance.

15. The optically functional material of claim 14, wherein the colored substance is selected from the group consisting of methyl blue, lemon yellow, rhodamine 6G, red acrylic resin masterbatch, orange epoxy masterbatch, blue epoxy masterbatch, green polyurethane resin masterbatch and combinations thereof.

16. The optically functional material of claim 1, wherein the luster of the optical functional material is infrared light, visible light or ultraviolet light having a wavelength of 200˜2000 nm.

17. The optically functional material of claim 1, wherein the luster of the optical functional material is visible light having a wavelength of 480˜550 nm, 580˜600 nm, 550˜600 nm, or 600˜640 nm.

18. A preparation method for the optically functional material of claim 1, comprising the following steps:
(1) dispersing the nano-microspheres in a continuous phase to form a colloidal dispersion of the nano-microspheres;
(2) under the action of external force, self-assembling the colloidal dispersion of the nano-microspheres to form periodically closely arranged structure at the phase interface; and,
(3) removing part or all of the continuous phase as required.

19. The preparation method of claim 18, wherein the nano-microspheres in the step (1) are tinted nano-microspheres; and/or,
in the step (2), after removing the continuous phase, the voids between the nano-microspheres of the nano-microsphere layer are filled with a filling medium; and/or,
the phase interface described in the step (2) comprises a gas-solid interface, a gas-liquid interface, a solid-solid interface or a liquid-liquid interface; and/or,
the external force described in the step (2) comprises capillary force, electrostatic force, magnetic force, gravity, van der Waals force or hydrogen bond.

20. An application of the optically functional material of claim 1 in preparation of ink pastes, pigment toners, or film coatings.
